(19) United States
(12) Patent Application Publication
(10) Pub. No.: US 2009/0132756 A1
(43) Pub. Date: May 21, 2009

(54) Portable flash memory storage device that may show its remaining lifetime

(76) Inventor: Hsiang-An Hsieh, Sijhih City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/007,997

(22) Filed: Jan. 18, 2008

(30) Foreign Application Priority Data
Nov. 16, 2007 (TW) 96219420

(51) Int. Cl. G06F 12/02

(52) U.S. Cl. 711/103; 711/E12.008

(57) ABSTRACT

A portable flash memory storage device that may show its remaining lifetime according to this invention is provided, in which an average erase count that is stored may be read and, after being processed and converted, is formed into a piece of information on its remaining lifetime that is further shown on a display screen of a display module in the portable flash memory storage device, and an erase is implemented on the portable flash memory storage device for an automatic update of average erase count, allowing a user to decide to replace the device or not depending on a latest remaining lifetime information.

### BACKGROUND OF THE INVENTION

1. Field of the Invention

This invention relates to a storage device and particularly to a portable flash memory storage device that may show its remaining lifetime.

2. Description of Related Art

Generally, the nonvolatile memory of a flash memory storage device, namely a storage block in a flash memory storage medium module may be repeatedly arranged and erased. However, each storage block or physical address may be erased several times only; i.e., the cycle of arranging and erasing each storage block is limited. After a certain amount of cycles the storage block becomes worn down and the available memory capacity becomes small. When the storage block is worn down, a loss of storage capacity of the flash memory storage device occurs or the performance of the device obviously degrades, and a user of the device, may lose stored data or may not be able to store any data.

Thus, in order to increase the possibility of adequate and average wear of the storage block in the flash memory storage device, and the service life of flash memory storage device, which are mentioned in U.S. Pat. No. 7,035,967, titled “Maintaining an average erase count in a non-volatile storage system”, average counts of erase of each storage block of several storage blocks in the non-volatile memory of a memory system are added for the total amount, and the sum is divided by a sum of all of the storage blocks for the average erase count of each storage block, thereby the service life of flash memory storage device being increased.

Besides, currently, there are more and more types of portable flash memory storage devices. The service life of a small number of flash memory storage device has been increased by averaging the counts of erase of each storage block in the storage device. However, most of the flash memory storage devices in the market show only information on the remaining capacity or on operation of the device. It may temporarily satisfy a user, but there are some defects at the time of use. A display module in the conventional flash memory storage device may show only the information on the remaining capacity and internal status of operation but cannot indicate the remaining service life of the flash memory storage device. When the storage block in the flash memory storage device is worn down, the user is not advised to back up data stored in the storage block and thus may face loss of data.

Consequently, because of the technical defects of described above, the applicant keeps on carving unflaggingly through wholehearted experience and research to develop the present invention, which can effectively improve the defects described above.

### SUMMARY OF THE INVENTION

A portable flash memory storage device that may show its remaining lifetime according to this invention is provided, in which an average erase count that is stored may be read and, after being processed and converted, is formed into a piece of information on its remaining lifetime that is further shown on a display screen of a display module in the portable flash memory storage device, and an erase is implemented on the portable flash memory storage device for an automatic update of average erase count.

The portable flash memory storage device that may show its remaining lifetime according to this invention comprises a power modulation circuit, a flash memory storage medium module, a storage medium interface, a keystroke input unit, a control unit, a system terminal interface, a display device interface, and a display module.

The control unit is connected to the storage medium interface, the keystroke input unit, the system terminal interface, and the display device interface. The storage medium interface is connected to the flash memory storage medium module. The display device is connected to the display module. The system terminal interface is connected to an application system outside the portable flash memory storage device.

After a user enables the power modulation circuit, the control unit reads the average erase count from the flash memory storage medium module through the storage medium interface and processes and converts it correspondingly into the information on the remaining lifetime for showing the information on the display screen of the display module.

When the user inputs a command through the keystroke input unit to get the remaining lifetime, the control unit will reply to an update remaining lifetime command and show it on the display screen of the display module. When what is inputted is a normal command, the control unit transfers data. When what is inputted is a write command, the control unit records a status of data change in the flash memory storage medium module for a further update average erase count.

### BRIEF DESCRIPTION OF THE DRAWINGS

FIG. 1 is a block diagram of a portable flash memory storage device that may show its remaining lifetime according to this invention; and

FIG. 2 is a flow chart of the portable flash memory storage device that may show the remaining lifetime according to this invention.

### DETAILED DESCRIPTION OF THE PREFERRED EMBODIMENTS

Now, the present invention will be described more specifically with reference to the following embodiments. It is to be noted that the following descriptions of preferred embodiments of this invention are presented herein for purpose of illustration and description only; it is not intended to be exhaustive or to be limited to the precise form disclosed.

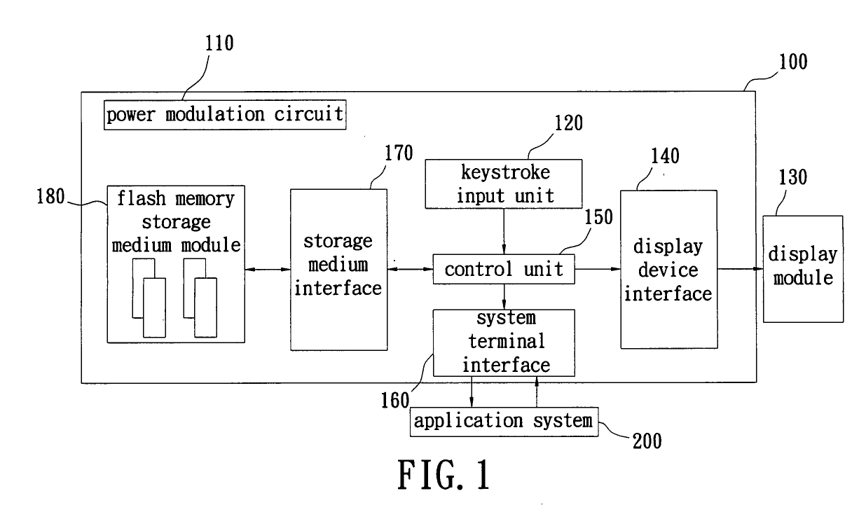

Refer to FIG. 1 illustrating a block diagram of a portable flash memory storage device that may show its remaining lifetime according to this invention. The portable flash memory storage device 100 comprises a power modulation circuit 110, a keystroke input unit 120, a display module 130, a display device interface 140, a control unit 150, a system terminal interface 160, a storage medium interface 170, and a flash memory storage medium module 180.

The keystroke input unit 120 is provided for a user to input control commands corresponding to various function keys (not shown) provided on a surface of the portable flash memory storage device 100 to the portable flash memory storage device 100; thus the user further controls the portable flash memory storage device 100 depends on his or her requests and favorites.

The display module 130 shows an internal status of operation of the portable flash memory storage device 100, allowing the user to read the status of operation of the device 100 through the information shown on a display screen of the display module 130 further a further control through the keystroke input unit 120. Thus, the information shown by the display module 130 may be given in a manner of characters, graphs, or numerals and may be bistable display device, a LED display device, or a LCD display device.

The display device interface 140 is connected to the display module 130 to serve as a bridge of communication between the internal components and the display module 130 in the portable flash memory storage device 100, receiving the information given by the device 100 and sending it to the display module 130 to show.

The system terminal interface 160 is a channel of connection between the device 100 and an external interface. Thus, the system terminal interface 160 is connected to an application system 200 so that the device 100 may transmit data to and communicate with the application system 200 through the system terminal interface 160. The application system 200 may be a personal computer (PC), a Notebook PC, a personal digital assistant (PDA) or the like.

The flash memory storage medium module 180 is used to communicate with the components in the device 100 through the storage medium interface 170. The application system 200 transmits to the application system 200 the data provided by the system terminal interface 160 or stored in the system terminal interface 160 or the data that may be controlled or processed by the user. The data stored by the flash memory storage medium module 180 contains a multimedia file, a suite of application software, a text file and the like.

The control unit 150 is connected to the keystroke input unit 120, the display device interface 140, the system terminal interface 160, and the storage medium interface 170, and used to control the components of display device interface 140, the system terminal interface 160, and the storage medium interface 170 in the device 100 following the control commands given by the keystroke input unit 120, record the internal status of operation of the device 100, and process the data in the device 100.

Thus, when the flash memory storage medium module 180 erases the data, the control unit 150 records a historical count of erase executed by the module 180 and stores it in a predetermined storage block in the module 180 for an easy review next time.

The power modulation circuit 110 is used to obtain a power supply meeting an interface standard from the system terminal interface 160, modulate the power supply into a power supply required the component of each unit, and supply the power to each component in the device 100 so as to operate with sufficient power supply. Besides, the power modulation circuit 110 may also be provided with an independent internal power source, and when the application system 200 is connected, the power source may be supplied from the application system 200 through the system terminal interface 160, an internal non-charging battery or an external or built-in charging battery.

When the flash memory storage medium module 180 transmits data to and receives data from the application system 200 and the display module 130, because operating voltages of the system terminal interface 160, control unit 150, display module, and flash memory storage medium module 180 are different, the power modulation circuit 110 may obtain the power source from the system terminal interface 160 or the internal independent power source to modulate, and may supply the operating voltage to the display module 130 and the flash memory storage medium module 180 through the display device interface 140 and the storage medium interface 170. Further, upon a model number, a specification, and/or a brand as an ID data of the flash memory storage medium module 180, the power modulation circuit 110 may adjust the operating voltage of the module 180.

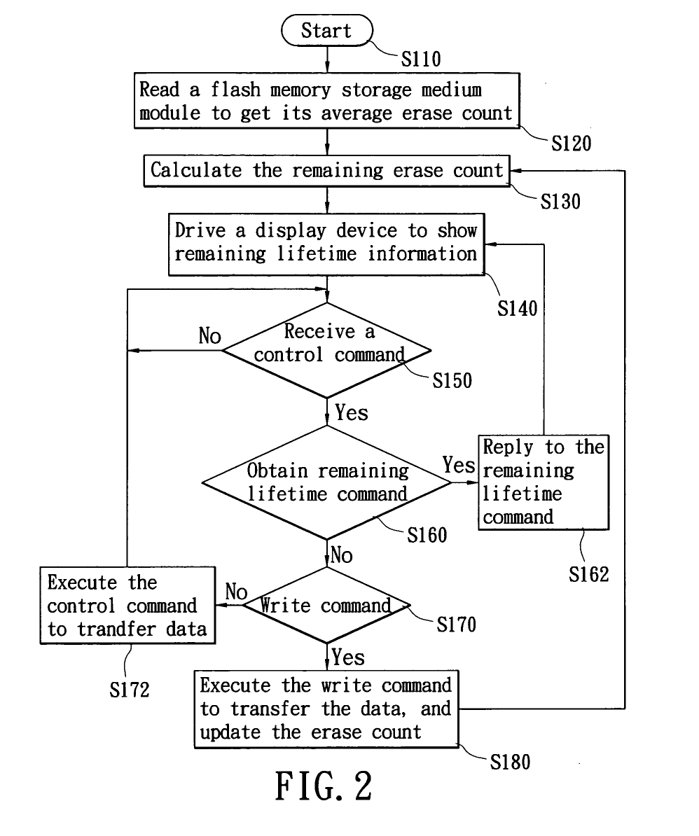

Refer to FIG. 2 illustrating a flow chart of the portable flash memory storage device that may show its remaining lifetime according to this invention. When the user enables the keystroke input unit 120 in the device 100 in the condition of normal operation of power modulation circuit 110, the control unit 150 drives each component in the device 100 to operate, as indicated at step S110.

Firstly, the control unit 150 drives and reads the flash memory storage medium module 180 through the storage medium interface 170 to further get an average erase count in a specific storage block in the module 180, as indicated at step S120.

After getting the average erase count, the control unit 150 compares the count with a standard service life predetermined by the module 180 to calculate its remaining erase count, as indicated in step S130. The calculated remaining erase count is converted into information on the remaining lifetime and further transmitted through the display device interface 140 to the display module 130 for a show, as indicated at step S140. The information on remaining lifetime shown on the display screen of the display nodule 130 may be given as characters, graphs, or numerals.

Next, the control unit 150 further waits and determines whether the user inputs the control command to the control unit 150 through the keystroke input unit 120 to control the device 100, as indicated at step S150.

If not receiving the control command inputted by the user through the keystroke input unit 120, the control unit 150 keeps on waiting until receiving the control command. When receiving the control command inputted by the user through the keystroke input unit 120, the control unit 150 further determines whether the received control command is a getting remaining lifetime command, as indicated at step S160.

When the control unit 150 determines the control command is a getting remaining lifetime command, the control unit 150 gets a latest remaining erase count from the specific storage block in the module 180, and after processing and converting the count, the unit 150 replies to the remaining lifetime information on the display screen of the display module 130, as indicated at step S162, further allowing the user to read the information on the display screen and decide to purchase a new portable flash memory storage device 100 or not, as indicated at step S140.

When the control unit 150 determines the control command is not a getting remaining lifetime command, the control unit 150 keeps on determining whether the control command is a write command or not, as indicated at step S170. The write command indicates that the user changes the data stored in the flash memory storage medium module 180 through the application system 200 connected to the system terminal interface 160 or directly through the keystroke input unit 120.

When the control unit 150 determines the control command to be not the write command, the control command is a normal command, such as the control command to play a multimedia file, listen to broadcast, search or the like. The control unit 150 further executes what is defined by the control command and transmits data, as indicated at step S172.

For example, suppose the device 100 according to this invention is an MP3 flash drive and when the user inputs the control command with respect to a multimedia file playback, the control unit 150 executes the operation defined by the control command; namely, the multimedia file the user want to play back is fetched from a storage block in the module 180 through the storage medium interface 170 and, after being processed, is played by an audio playback module (not shown), and through the display device interface 140, the status of execution of the control command is shown on the display screen of the display module 130.

When the control unit 150 determines the control command to be the write command, the control unit 150 further executes the operation defined by the control command; namely, data is added from the application system 200 to the module 180, or the data stored in the module 180 is deleted or moved so as to make the module 180 erase; the control unit 150 also further records the erase to update the average erase count in the specific storage block of the module 180; namely, the average erase count in the module 180 adds 1, as indicated at step S180.

Finally, when the control unit 150 finishes in executing the write command, step S130 returns and the remaining erase count is re-calculated and converted for the updated remaining lifetime information. The updated remaining lifetime information is further shown on the display screen of the display module 130, as indicated at step S140, and what are implemented at steps S150 through S180 are repeated.

From the description above, the flash memory storage device 100 may be a SD memory card, a USB flash drive and the like.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A portable flash memory storage device that may show its remaining lifetime, comprising:
a system terminal interface;
a control unit connected to the system terminal interface to execute and process data and to control and record a status of operation of a component in the portable flash storage device;
a flash memory storage medium module that stores data given by the control unit and provides the control unit with data and an average erase count; and
a display module used to display the data given by the control unit and display remaining lifetime information corresponding to the average erase count, in which the remaining lifetime information is obtained from the control unit by processing the average erase count.

2. The portable flash memory storage device that may show its remaining lifetime according to claim 1, wherein the device further comprises a keystroke input unit connected to the control unit, allowing a user to input a control command to the control unit.

3. The portable flash memory storage device that may show its remaining lifetime according to claim 2, wherein when the control command is a write command, the control unit executes the write command and updates the average erase count.

4. The portable flash memory storage device that may show its remaining lifetime according to claim 2, wherein when the control command is a getting remaining lifetime command, the control unit replies and shows the remaining lifetime information.

5. The portable flash memory storage device that may show its remaining lifetime according to claim 2, wherein when the control command is a normal command, the control unit only executes the normal command and transmits data.

6. The portable flash memory storage device that may show its remaining lifetime according to claim 1, wherein the device further comprises a storage medium interface connected to the control unit and the flash memory storage medium module to adjust a voltage level for a data exchange between the control unit and the flash memory storage medium module and serve as a bridge for data transfer.

7. The portable flash memory storage device that may show its remaining lifetime according to claim 1, wherein the device further comprises a display device interface connected to the control unit, and the display module processes data provided by the display device interface to be displayed so that the data transferred by the control unit may be shown on a display screen of the display module.

8. The portable flash memory storage device that may show its remaining lifetime according to claim 1, wherein the display module is a bistable display device.

9. The portable flash memory storage device that may show its remaining lifetime according to claim 1, wherein the remaining lifetime data may be given by characters, graphs, or numerals.

10. The portable flash memory storage device that may show its remaining lifetime according to claim 1, wherein the control unit uses a default standard service life and the average erase count to generate the remaining lifetime information.
